(19) United States
(12) Patent Application Publication
(10) Pub. No.: US 2009/0138478 A1
(43) Pub. Date: May 28, 2009

(54) Method and Apparatus to Facilitate Participation in a Networked Activity

(75) Inventors: Venu Vasudevan, Palatine, IL (US); Mat Hans, Hoffman Estates, IL (US); Jonathan R. Engelsma, Hudsonville, MI (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 11/945,390

(22) Filed: Nov. 27, 2007

(51) Int. Cl. G06F 17/30

(52) U.S. Cl. 707/10; 707/E17.032

(57) ABSTRACT

Participation in a particular networked activity (from amongst a plurality of candidate networked activities) by a plurality of members of an affinity group is facilitated by gathering (101) information regarding availability of candidate members of the affinity group to participate in at least either of two of the plurality of candidate networked activities and then automatically using (102) that information to identify a particular networked activity as being suitable for at least two of the plurality of members of the affinity group. The gathered information can, as desired, comprise inferential information and/or direct information regarding the availability of such candidate members to participate in such activities.

### TECHNICAL FIELD

This invention relates generally to networked activities and more particularly to multi-participant networked activities.

### BACKGROUND

End-user platforms of various kinds are known in the art with new versions and varieties being introduced regularly. Many of these end-user platforms are portable and are readily usable by mobile end users. Also in many cases, these end-user platforms are networked and hence have access to remote resources of various kinds including real-time access (directly or indirectly) to other end users. (As used herein, end-user platforms will be understood to be networked when such a platform is able to communicate over a wired and/or a wireless medium to share data and other resources. This can comprise, of course, so-called on-line activities presently accomplished through interaction with and via the extranet commonly known as the Internet.)

Such accessibility by large numbers of end users, in turn, has led to the creation of affinity groups. (As used herein, affinity groups will be understood to refer to both formal and informal organized groups of end users and hence can include both open and closed membership entities as well as public and private entities. As used herein, this expression will also be understood to include groups of end users that are formed and/or maintained by the end users themselves or by some third party entity on their behalf. Inclusion within a given affinity group can be explicit (as where the members are aware of their membership status) or implicit.) Via such affinity groups, end users are often able to identify, locate, and participate in group activities of interest.

One example in this regard is an affinity group of end users interested in playing multi-player games of varying kinds and scale of participation via their networked end-user platforms. It is known, for example, to facilitate organized gameplay by various members of a given game-playing affinity group as a function of some one or more criteria of interest, such as level of skill, membership in a sub-affinity group within the larger affinity group, and so forth. While suitable and useful for many application settings, however, prior practice in these regards are not universally satisfactory.

For example, in many cases the process by which a given end user must express interest in playing in a particular game can require many minutes. This duration of time, however, may exceed the amount of time a given would-be game player may have available at the present time. This may be the case, for example, with an end user who is standing in a five minute line and who wishes to entertain themselves for a very few minutes with a networked diversion. In such a case, the end user will typically forgo the opportunity. This, in turn, can lead to reduced end user satisfaction as well as possible lost revenue opportunities for a corresponding service provider (or providers).

### BRIEF DESCRIPTION OF THE DRAWINGS

The above needs are at least partially met through provision of the method and apparatus to facilitate participation in a networked activity described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention; and

FIG. 4 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, participation in a particular networked activity (from amongst a plurality of candidate networked activities) by a plurality of members of an affinity group is facilitated by gathering information regarding availability of candidate members of the affinity group to participate in at least either of two of the plurality of candidate networked activities and then automatically using that information to identify a particular networked activity as being suitable for at least two of the plurality of members of the affinity group. The gathered information can, as desired, comprise inferential information and/or direct information regarding the availability of such candidate members to participate in such activities.

By one approach, a server can serve to gather such information and to then use that information as described. Such a server can be dedicated to such a purpose on behalf of only this one particular affinity group or can provide such services and functionality to a wider audience as desired.

These teachings are particularly useful when applied in conjunction with networked games (though those skilled in the art will readily recognize numerous other useful application settings as well). In such a case, these teachings can accommodate the use of such information to determine, for example, which game (or games) of a given set of candidate games can likely be completed by participating members within a period of time that is mutually available to each such participating member. Those skilled in the art will further appreciate that these teachings are readily applied in either a push and/or a pull operational setting and will thereby accommodate both proactive end users who take action to instigate a game as well as reactive end users who chose to await a notice regarding some present available gaming opportunity.

These teachings are readily and economically implementable and leveragable using a wide variety of implementing components and architecture. It will also be recognized that these teachings are highly scalable and will accommodate a wide variety and kind of affinity groups, affinity group membership sizes, and networked activities.

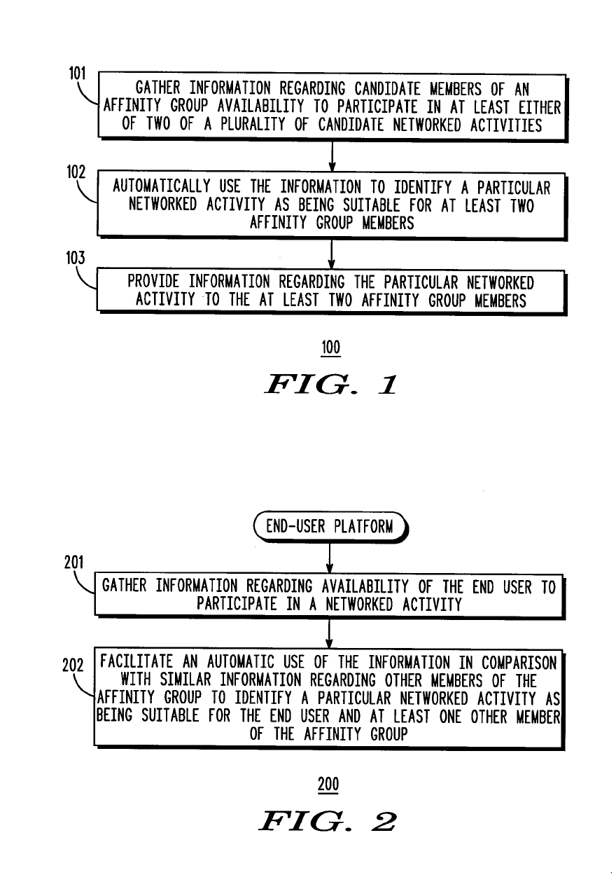

These and other benefits may become clearer upon making a thorough review and study of the following detailed description. Referring now to the drawings, and in particular to FIG. 1, an illustrative process 100 suitable to represent at least certain of these teachings will be described.

This process 100 sets forth a method to facilitate participation in a particular networked activity from amongst a plurality of candidate networked activities by a plurality of members of an affinity group. As noted above, these networked activities can comprise any of a wide variety of activities. For the sake of illustration but not for the purposes of limitation, these candidate networked activities will be presumed in this description to comprise a plurality of games. These games can include, in particular, multi-player games. These might comprise, for example, anything from two-person games to massively multiplayer games (which may involve dozens to hundreds or even thousands of participants) as desired.

This process 100 provides for gathering 101 information regarding availability of candidate members to participate in at least either of two of the plurality of these candidate networked activities. This information can comprise, for example, information regarding a time at which a given one of the candidate members will become available in this regard. This can comprise an indication of present availability but can also comprise a calculation or estimation of some future time at which the candidate member will become available. This information can also comprise, if desired, information regarding a duration of time during which a given one of the candidate members will remain available to participate in a networked activity.

By one approach, these at least two candidate networked activities differ from one another with respect to at least one aspect of participation, such as, but not limited to, a duration of time that is (likely or specifically) required to complete the activity, one or more network resources (such as bandwidth, ability to access a given network resource, and so forth) required to participate in the activity, one or more end user platform resources (such as processing speed, operating system, browser capability, user interface, graphics capability, and so forth) required to participate in the activity, or the like.

This step of gathering 101 information can comprise, for example, gathering inferential information regarding the availability of the candidate members to participate in these at least two of the plurality of candidate networked activities. Various kinds of inferential information may suffice for these purposes. Examples include, but are not limited to:

geographic location information (such as a presence of a given candidate member at a given venue or location, such as a movie theater, a vehicle on a roadway, at a place of business, at a hospital, at a sports stadium, and so forth);

movement information (such as whether a given candidate member is presently moving on a highway, on a commuter railway, or is walking along a city street);

networked activities information (such as whether a given candidate member is presently engaged in other networked activities such as another game (and if so, the present state of that game), shopping, uploading activities, downloading activities, file transfer activities, and so forth);

cognitive loading information (such as whether a given candidate member is presently engaged in some task or activity, such as driving a vehicle or attending a class, that requires a significant amount of their attention or whether they are engaged in some task or activity, such as working a crossword or Soduko puzzle on their end-user device, that requires a lesser amount of attention or that will readily tolerate an interruption);

on-device information (such as when a given candidate member is browsing their contact list on their cellular phone and linger on the picture of one friend in particular, which information can then lead to investigating the present availability of that particular friend to participate in networked activity).

calendar schedule information (such as when a given candidate member is scheduled to be commuting on public transport, walking on a treadmill in a health club, attending a meeting with a customer, and so forth);

historical behavior information (such as a record of information regarding when a given candidate member tends to be using public transport, taking a coffee break, actively seeking to participate in a networked activity, and so forth);

resources availability to support the networked activities; and/or

emotional state information (such as information regarding a given candidate member's present state of relaxation or contemplation as versus agitation and hence their ability to both give their attention to a given activity and to wish to offer such attention); to note but a few examples in this regard.

Such inferential information can be gathered from any of a wide variety of informational repositories (such as one or more corresponding presence servers) and/or sensors of one kind or another (such as a global positioning system navigation system, a local environment detection system, and so forth). Such information repositories and/or sensors can comprise a part of the candidate member's end user platform and/or can comprise a resource that is otherwise available for these purposes. Such availability may be arranged using any number of known techniques in this regard. This might include, for example, a condition of registering to become a member of the aforementioned affinity group.

This step of gathering 101 information can also comprise, in lieu of or in combination with the aforementioned gathering of inferential information, the gathering of direct information regarding at least present availability of such candidate members. Those skilled in the art will understand that a gathering of direct information refers to receiving input directly from the candidate member regarding their own availability. This can accommodate, for example, presenting a given candidate member with an information input opportunity (using, for example, a local application program or a browser-based interface) by which the candidate member can directly indicate their own present availability, a duration of time during which they expect to remain available, and so forth.

It will also be understood by those skilled in the art that this step of gathering 101 information can comprise a background activity and/or a foreground activity. When conducted as a background activity, the information of interest is gathered prior to the availability of a given candidate member. When gathered as a foreground activity, the information of interest is collected in response to some current indication from a given member of their interest in currently (or soon) participating in a networked activity.

This process 100 then provides for automatically using 102 this gathered information to identify a particular networked activity from amongst the plurality of candidate networked activities that is suitable for at least two of the plurality members of the affinity group. As one simple illustration in this regard, this step can comprise identifying at least two affinity group members who are both available at a same time and who are both likely to remain available for a sufficient amount of time to permit the networked activity to be conducted in a satisfactory manner. For example, a particular game, which ordinarily requires only about ten minutes to play when played by three participants, may be so identified for three affinity group members who are all available at the same time for about that same amount of time.

Of course, other selection and filtering criteria can be considered if desired. This can serve to accommodate, for example, limiting the pool of candidate games for a given member to only a specific few that this member may be previously identified as being their preferred activities. Another useful parameter to consider may be a given member's skill level, experience level, or the like with respect to a particular game or game genre. Other examples of this kind will readily occur to those skilled in the art and are similarly well accommodated by these teachings.

Having identified such a networked activity, this process 100 will then optionally accommodate providing 103 that information to the corresponding affinity group members. This can comprise, for example, providing 103 such information in response to a direct input from at least one of these affinity group members. By this approach, the information is essentially pulled by the affinity group member who instigated the direct input. This step can also comprise, however, pushing the information in the absence of a direct input from any of the affinity group members. Using this approach, the affinity group members can be notified whenever a suitable gaming opportunity arises.

There are various ways by which these steps can be carried out. By one approach, a server-based approach can support the desired functionality. Using this approach, a server can be employed to gather the aforementioned information and to then automatically use the information to identify the particular networked activity. Server technology and methodology is well understood in the art and requires no further elaboration here suffice to note that the server architecture itself can be scaled as appropriate to suit the anticipated or experienced demands of a given application setting. By another approach, the end-user platform itself can serve in these regards. In such a case, these teachings are readily implemented by the end-user platform (such as, for example, a cellular telephone or the like) alone or in cooperation and conjunction with other such end-user platforms. Such architectural processing options are well known and understood in the art and require no further elaboration here.

Referring now to FIG. 2, the end user platforms as used by the aforementioned affinity group members can be configured and arranged (via, for example, suitable corresponding programming) to carry out a process 200 that supports these teachings. This can comprise, for example, using the end-user platform to gather 201 information regarding availability of the end user for that particular end-user platform to participate in a networked activity. As already noted above, this can comprise the use of inferential and/or direct informational sources.

The end-user platform can then serve to facilitate 202 the aforementioned automatic use of the gathered information (likely in comparison with similar information regarding other members of the affinity group to which this end user belongs) to identify a particular networked activity from amongst the plurality of candidate networked activities as being suitable for this end user and at least one of the other members of the affinity group. This facilitation step can comprise, at least in part, transmitting this information to the aforementioned server. The server, in turn, can arrange for the aforementioned informational comparison to occur to thereby identify the available pool of affinity group members that comprise the likely candidates for the selected networked activity.

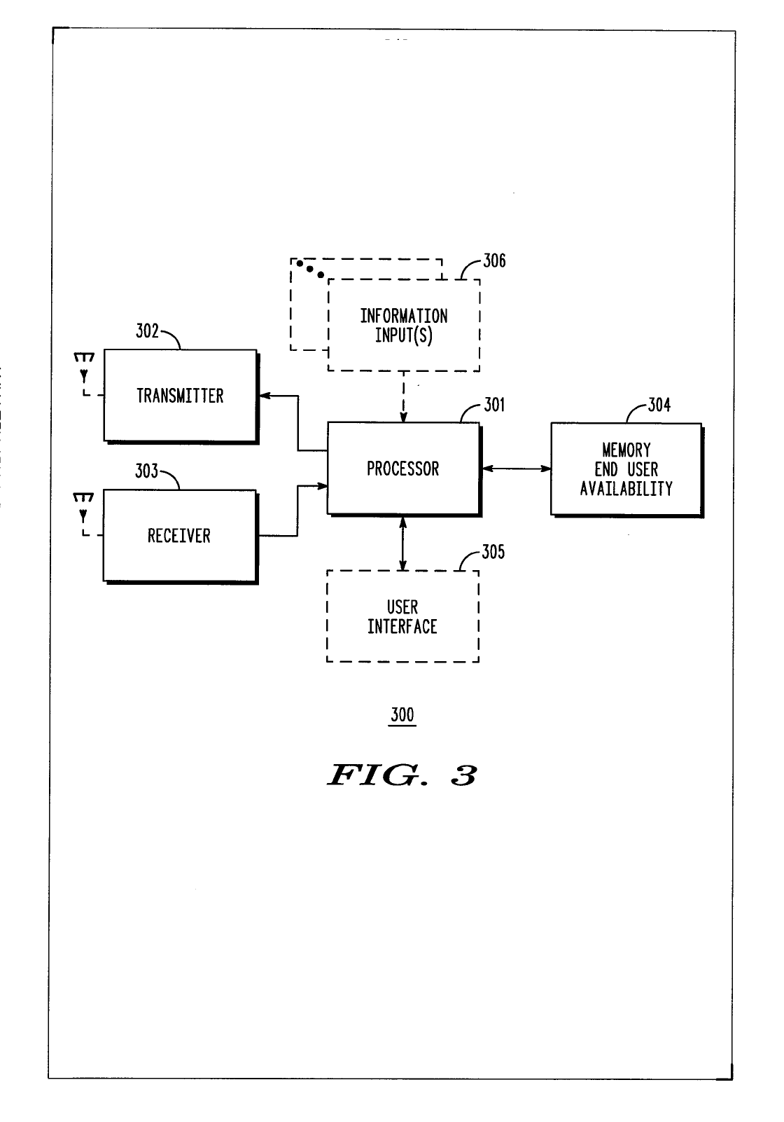

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

This illustrative example of an end-user platform 300 comprises a processor 301 that operably couples to a transmitter 302 (which may, if desired, comprise a wireless and/or a wireline transmitter), a receiver 303 (which may also comprise, as desired, a wireless and/or a wireline receiver), and a memory 304. This memory 304 can server to store, for example, the aforementioned information regarding availability of an end user of this end-user platform 300 to participate in a networked activity.

The processor 301 can comprise a hard-wired dedicated purpose platform or can comprise a partially or wholly programmable platform. Such architectural options are well known in the art and require no further elaboration here. This processor 301 can be configured and arranged (via, for example, suitable programming as will be well understood by those skilled in the art) to effect one or more of the steps, actions, and functionality described herein. This can comprise, for example, gathering at least some of the availability information described herein and transmitting that information to a network resource to thereby facilitate the use of that information in comparison with similar information regarding other members of the end user's affinity group to identify a particular networked activity from amongst a plurality of candidate networked activities as being suitable for the end user and at least one other of the affinity group members.

To assist in these regards, and as desired, this end-user platform 300 can further optionally comprise a user interface 305 by which the processor 301 can receive direct (or indirect) input from the end user regarding their availability and the like. This user interface 305 can also serve, if desired, as a means of conveying to the end user information regarding a networked activity as has been identified via practice of these teachings. Numerous technologies and methodologies are known in the art in this regard. As the present teachings are not overly sensitive to the selection of any particular approach in this regard, for the sake of brevity and the preservation of clarity additional elaboration in this regard will not be provided here.

The processor 301 can also optionally couple to one or more information inputs 306 as desired. These information inputs 306 can serve, for example, to provide the aforementioned inferential information. With this in mind, these information inputs can comprise, for example, geographic locators (such a global positioning system receivers), accelerometers, navigation platforms, gaze sensors, data monitors, user calendars, emotional state sensors, and so forth.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

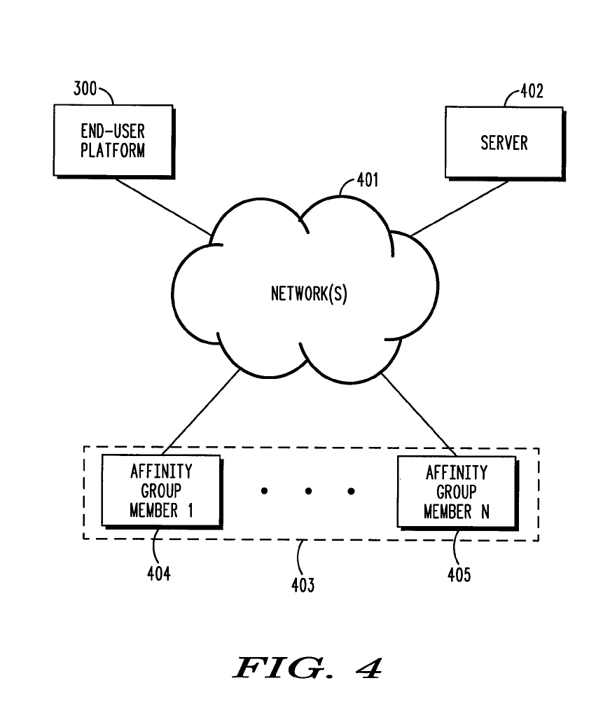

So configured, and referring now to FIG. 4, an end-user platform 300 can interact as described, via one or more networks 401 (such as, but not limited to, the Internet and including both wireline and wireless versions thereof) with a server 402 that gathers the described information from both the end-user platform 300 as well as a plurality of affinity group members 403 (represented here by a first affinity group member 404 through an Nth affinity group member 405, where N will be understood to comprise an integer greater than 1) and then uses that information to identify particular affinity group members (including the end user as corresponds to the end-user platform 300) and corresponding matching networked activities as a function, at least in part, of corresponding availability. (Those skilled in the art will recognize and understand that when using the end-user platform 300 itself to carry out the activities ascribed above to the server 402, the described server 402 as shown in FIG. 4 can be dispensed with.)

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, these teachings will readily accommodate various notions of “availability.” To illustrate, the end user's platform may determine that the end user is likely bored with a present game (as inferred, for example, by an indifferent rate of keystroke activity) and hence is “available” to participate in a different gaming opportunity notwithstanding their present participation in a given game. In such a case, it will be understood that “available” need not correspond only to being idle but can instead encompass other states of interest. As another example in this regard, the end user may be engaged in a given activity (such as general web browsing) that is understood to be less preferable to the end user than an available networked activity such as a particular game opportunity. As yet another example in this regard, the end user may be engaged in some activity (such as listening to music via their end user platform) that need not be necessarily terminated in order to participate in the networked activity. In such a case, again, the end user can be identified as being “available” notwithstanding their present engagement in another activity.

We claim:

1. A method to facilitate participation in a particular networked activity from amongst a plurality of candidate networked activities by a plurality of members of an affinity group, the method comprising:
gathering information regarding availability of candidate members to participate in at least either of two of the plurality of candidate networked activities;
automatically using the information to identify the particular networked activity from amongst the plurality of candidate networked activities as being suitable for at least two of the plurality of members of the affinity group.

2. The method of claim 1 wherein:
gathering information regarding availability of candidate members to participate in at least either of two of the plurality of candidate networked activities comprises using a server to gather the information; and
automatically using the information to identify the particular networked activity from amongst the plurality of candidate networked activities as being suitable for at least two of the plurality of members of the affinity group comprises using the server to automatically use the information to identify the particular networked activity.

3. The method of claim 1 wherein gathering information regarding availability of candidate members to participate in at least either of two of the plurality of candidate networked activities comprises, at least in part, gathering inferential information regarding the availability of candidate members to participate in at least either of two of the plurality of candidate networked activities.

4. The method of claim 3 wherein the inferential information comprises, at least in part, at least one of:
geographic location information;
movement information;
networked activities information;
cognitive loading information;
on-device information;
calendar schedule information;
historical behavior information;
resources availability to support the networked activities;
emotional state information.

5. The method of claim 3 wherein gathering information regarding availability of candidate members also comprises, at least in part, gathering direct information regarding at least present availability of candidate members.

6. The method of claim 1 wherein gathering information regarding availability of candidate members to participate in at least either of two of the plurality of candidate networked activities comprises, at least in part, gathering information regarding at least one of:
a time at which a given one of the candidate members will become available;
a duration of time during which a given one of the candidate members will remain available.

7. The method of claim 1 further comprising:
providing information regarding the particular networked activity to the at least two of the plurality of members of the affinity group

8. The method of claim 7 wherein providing the information comprises providing the information in response to a direct input from at least one of the at least two of the plurality of members of the affinity group.

9. The method of claim 7 wherein providing the information comprises pushing the information in the absence of a direct input from either of the at least two of the plurality of members of the affinity group.

10. The method of claim 1 wherein the plurality of candidate networked activities comprise a plurality of games.

11. The method of claim 10 wherein automatically using the information to identify the particular networked activity from amongst the plurality of candidate networked activities as being suitable for at least two of the plurality of members of the affinity group comprises, at least in part, determining which game of the plurality of games can likely be completed by participating members of the plurality of members of the affinity group within a period of time that is mutually available to the participating members.

12. A method comprising:
at an end-user platform:
gathering information regarding availability of the end user to participate in a networked activity;
facilitating an automatic use of the information in comparison with similar information regarding other members of an affinity group to which the end user belongs to identify a particular networked activity from amongst a plurality of candidate networked activities as being suitable for the end user and at least one of the other members of the affinity group.

13. The method of claim 12 wherein gathering information comprises, at least in part, gathering inferential information regarding the availability of the end user.

14. The method of claim 13 wherein the inferential information comprises, at least in part, at least one of:
geographic location information;
movement information;
networked activities information;
cognitive loading information;
on-device information;
calendar schedule information:
historical behavior information;
resources availability to support the networked activities;
emotional state information.

15. The method of claim 13 wherein gathering information also comprises, at least in part, gathering information directly from the end user regarding at least their present availability.

16. The method of claim 12 wherein facilitating an automatic use of the information comprises, at least in part, transmitting the information to a server where the comparison of the information with the similar information occurs.

17. An apparatus comprising:
a transmitter;
a receiver;
a memory having information stored therein regarding availability of an end user of the apparatus to participate in a networked activity;
a processor that is operably coupled to the transmitter, the receiver, and the memory, and that is configured and arranged to facilitate an automatic use of the information in comparison with similar information regarding other members of an affinity group to which the end user belongs to identify a particular networked activity from amongst a plurality of candidate networked activities as being suitable for the end user and at least one of the other members of the affinity group.

18. The apparatus of claim 17 wherein the processor is further configured and arranged to gather at least some of the information stored in the memory, at least in part, by gathering inferential information regarding the availability of the end user.

19. The apparatus of claim 18 wherein the inferential information comprises, at least in part, at least one of:
geographic location information;
movement information;
networked activities information;
cognitive loading information;
on-device information;
calendar schedule information.

20. The apparatus of claim 17 wherein the processor is further configured and arranged to facilitate an automatic use of the information by, at least in part, using the transmitter to transmit the information to a server where the comparison of the information with the similar information occurs.
